(19) United States
(12) Patent Application Publication
(10) Pub. No.: US 2007/0258406 A1
(43) Pub. Date: Nov. 8, 2007

(54) Method for handover in a wireless communication network

(75) Inventors: Tal Kaitz, Kiryat-Ono (IL); Mark Altshuller, Netanya (IL); Leonid Shousterman, Herzlia (IL); Dan Stopler, Holon (IL); Ran Yaniv, Kfar-Saba (IL); Guy Reina, Givatayim (IL)

Correspondence Address: BROWDY AND NEIMARK, P.L.L.C.;624 NINTH STREET, NW, SUITE 300, WASHINGTON, DC, 20001-5303, US

(73) Assignee: Alvarion Ltd., Tel-Aviv (IL)

(21) Appl. No.: 11/415,426

(22) Filed: May 2, 2006

(51) Int. Cl. H04Q 7/20

(52) U.S. Cl. 370/331; 455/436

(57) ABSTRACT

A method for carrying out a handover of servicing a mobile terminal from a currently serving base station to another base station in a cellular network, comprising the following steps. The currently serving base transmits information associated with the mobile terminal to one or more of its neighboring base stations. The neighboring station(s) respond by providing the serving base station with information related to the quality at which they are able to receive communications from the mobile terminal. Based on the responses received from the neighboring base stations, the serving base station selects which of its neighboring base stations will be the target base station for the mobile terminal. Upon selecting the target base station, a handover procedure is carried out, following which, the mobile terminal will receive and transmit communications via that target base station.

### FIELD OF THE INVENTION

The present invention relates to cellular communications networks and, in particular, to a handover process following which a different base station provides services to a given mobile terminal.

### LEGEND

The following are the meanings of certain abbreviations used hereinafter in the description of the invention:
BS—Base Station
DL—Down Link
HO—Handover
MSS—Mobile Subscriber Station (also used for mobile terminal).
UL—Up Link

### BACKGROUND OF THE INVENTION

Mobile units, e.g. telephones, laptop computers, etc. are known to be able to roam in wireless networks between various locations. Still, while roaming through various networks and sub-networks, they need to maintain their connectivity. Various aspects relating to this mode of operation were suggested by the IETF (“Internet Engineering Task Force”) and are described among others in a series of RFC (Request for Comment) documents.

One of the well-known problems associated with roaming mobile terminals, is, the need to change their serving base station, i.e. the BS through which those mobile terminals communicate with the network, while moving from one area in the network, to another. This need to change the serving base station may arise from any one or more reasons such as the mobile terminal moves to an area not properly covered by the currently serving base station, a high load is being experienced by the serving base station and the mobile terminal is currently located in an area that allows the terminal to be serviced by another base station, etc. In order to enable a smooth transition of communications between the first base station (the serving base station) and the second (the target) base station, a handover procedure is employed. Generally speaking the handover procedure comprises three major steps. A measurement step, in which the propagation and reception conditions are measured, and information is provided as to the need to perform handover, a decision step in which the network decides on the handover and determines which is the optimal BST for handover, and an implementation step, in which the mobile terminal is assigned to the base station which has been determined.

In prior art solutions the terminal performs measurements on the downlink propagation and reception conditions of neighboring base stations, which are included in a pre defined set, and the network determines the optimal base station in terms of downlink reception. However, in quite a few cases, such measurements do not provide adequate information on the propagation and reception conditions of the uplink. Examples of such cases are:

When Frequency division duplexing is employed, the frequency of the downlink channel is different from that of the uplink;

When different antenna configurations are used in the downlink and uplink;

When the base station employs adaptive antenna techniques, and in particular interference nulling. The interference observed on the uplink from the direction of the mobile terminal is different from base station to base station, and is not related to the reception conditions in the DL.

The problem of not having information on the uplink conditions is further exacerbated when the system is uplink limited.

In various prior art solutions, the measurements include the reception conditions of the uplink to the serving base station. This provides information on the need to perform handover, but does not alleviate the problem of selecting the optimal base-station.

### SUMMARY OF THE INVENTION

It is an object of the present invention to provide a better service experience to the user (for example IP session continuity).

It is another object of the present invention to provide a method and device that enable carrying out handover processes in a more efficient way.

It is yet another object of the present invention to reduce the utilization of the cellular network resources while carrying out a handover process when a mobile terminal switches from one BS to the next.

Other objects of the invention will become apparent as the description of the invention proceeds. Thus according to an embodiment of the present invention, there is provided a method for use in a cellular network comprising at least two neighboring base stations, one of which (serving BS), is currently in communication with at least one mobile subscriber station (MSS), which method comprises the steps of:

transmitting by the serving BS towards the at least one neighboring base station, PHY and/or MAC information associated with the at least one MSS;

responding by the at least one neighboring base station to that transmission by providing the serving base station with information related to the reception of communications from the at least one MSS by the corresponding at least one neighboring base station;

selecting by the serving BS, which of the at least one neighboring base station shall be the target base station for the handover procedure;

carrying out a handover procedure between the serving base station and the target base station, following which the at least one MSS will receive and transmit communications via that target base station.

According to another embodiment of the invention the step of transmitting PHY and/or MAC information by the serving base station, is preceded by a step of determining that a handover procedure should be carried out for the at least one MSS. This determination that a handover procedure should be carried out, may be triggered either by the serving base station or by the at least one MSS.

By still another embodiment of the invention, the PHY and/or MAC information associated with the at least one MSS, is information sufficient to allow identifying the at least one MSS for the at least one neighboring base station, thereby allowing the at least one neighboring BS to monitor the reception conditions of communications transmitted by the at least one MSS, at the at least one neighboring base station.

According to still another embodiment of the invention, the step of transmitting further comprises transmitting by the serving BS to its at least one neighboring base station, queries relating to the reception conditions of the at least one MSS at the at least one neighboring base station.

By yet another embodiment of the invention, the step of responding by the at least one neighboring base station comprises providing the serving base station with values of pre-defined reception parameters associated with the reception of communications from the at least one MSS at the responding neighboring base station.

In accordance with still another embodiment of the invention, the step of transmitting PHY and/or MAC information is carried out on a regular basis by serving base station. Preferably, when this step is carried out on a regular basis, it will provide information which relates to at least one or more MSS which reception by the serving base station are the weakest from among the MSS communicating with that serving base station.

### BRIEF DESCRIPTION OF THE DRAWINGS

FIG. 1—presents a flow chart demonstrating the method provided by the present invention.

### DETAILED DESCRIPTION OF THE INVENTION

A better understanding of the present invention is obtained when the following non-limiting detailed description is considered in conjunction with the following drawings.

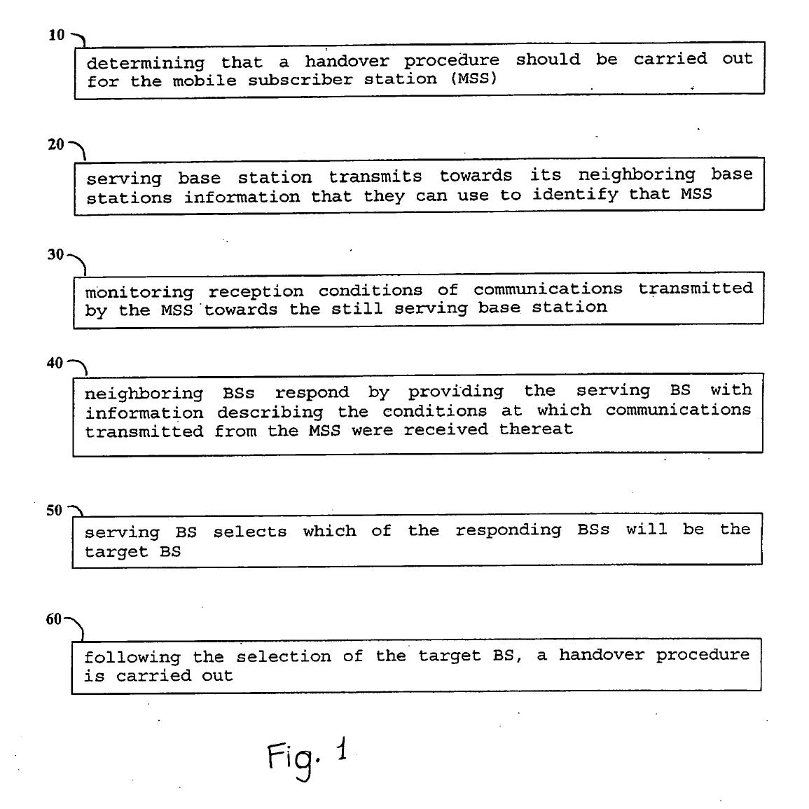

As will be appreciated by those skilled in the art, one of the objects of the method provided by the present invention, is, to allow the operator to manage its wireless network in such a way that would allow terminal serviced by one base station to be handover to another (target) base station. Let us consider now FIG. 1 which is a schematic flow chart of a method exemplifying the present invention. In step 10, a determination is made that a handover procedure should be carried out for the mobile subscriber station (MSS). This determination can be made by either the serving base station when the reception of the MSS gets to be too weak, or when the load associated with the serving base station increases, etc., or in the alternative, the determination that a handover procedure is required, is made by the base station, e.g. when the communications transmitted by the serving base station are received for example in a poor quality.

Next, the serving base station transmits towards its neighboring base stations (step 20), information that will be used by the neighboring station to identify that MSS, e.g. PHY and/or MAC information associated with the MSS. Receiving this information by the neighboring base stations, allow them to monitor the reception conditions of communications that are transmitted by the MSS towards the still serving base station (step 30). This transmission may further include one or more queries identifying certain reception parameters which the serving base station would require in order to establish if a handover procedure shall take place, and if in the affirmative, which of the neighboring base station will be the target (new) base station.

Next, the neighboring base stations respond to the serving base station (step 40) by providing the latter with information related to the conditions at which communications transmitted from the MSS were received at each of the responding base stations. As will be appreciated by those skilled in the art, steps 20 to 40 described above, may be carried out also prior to making a determination that a HO procedure is required (step 10). In such a case, the information reported by the various neighboring BSs to the serving BS may later be used when it is determined that the HO procedure is required (i.e. before HO messages are exchanged). This embodiment should be considered as being encompassed by the present invention. As will be also appreciated by those skilled in the art, if the quality of that reception at one or more of the neighboring base station is less than a pre-defined level, that one or more base station may simply avoid responding to the serving base station's approach, thereby will not be considered by the serving base station as adequate candidates for being a target base station for that MSS. In addition, the responding base stations may provide the serving base station with information related to their current traffic load, information which may assist the serving base station in selecting the new target base station. This information may be provided for example, only in case the load of a neighboring base station is about to reach a pre-defined threshold. In addition, if the neighboring base station has already reached that pre-defined threshold, it may decide not to respond to the approach made by the serving base station.

The response information provided by the neighboring base stations is based on measurements taken at these neighboring base stations and performed on regular data transmissions or on dedicated sounding signals. The measured parameters may preferably include one or more of the following:
Received signal strength;
Signal to noise ratio;
Delay spread; and
Effective exponential SNR as function of beta parameter.

In addition to the above parameters, the neighboring base station may indicate to the serving base station the reliability of the measurement.

When adaptive antenna systems are employed, the neighboring base station may additionally report the amount of interference observed from the direction of the mobile subscriber station.

When the measurement is performed on regular data transmission, it may be carried out on data symbols or subcarriers, or on pilot symbols or subcarriers. When carrying the measurement on data symbols or subcarriers, the measurement may be performed by decoding regular transmissions of that BS, re-encoding, re-modulation and finally subtracting the resulting signal from the received signal. By following this procedure, the message to be measured is revealed. A similar process may be used when carrying out the measurement on pilot symbols or subcarriers.

Following the receipt of these responses, the serving base station selects which of the responding base station will be the target base station (step 50). As mentioned before, if the responding base stations provide the serving base station with information about their current load, this information may be used also as a factor when the serving base station makes the selection. For example, if two neighboring base station report about the same reception values, the base station that will be selected as the target base station can be the one with the less current load.

Once the target base station has been selected, a handover procedure as known in the art per se is carried out (step 60).

As will be appreciated by those skilled in the art, the example provided shows a direct messaging procedure between the BSs. However, similar processes may be used when messages are sent through intermediate GWs, without departing from the scope of the present invention.

It is to be understood that the above description only includes some embodiments of the invention and serves for its illustration. Numerous other ways of carrying out the methods provided by the present invention may be devised by a person skilled in the art without departing from the scope of the invention, and are thus encompassed by the present invention.

1. A method for use in a cellular network which comprises at least two neighboring base stations, one of which is a serving base station currently in communication with at least one mobile subscriber station (MSS), which method comprises the steps of:
transmitting by said serving BS information associated with said at least one MSS, to said at least one neighboring base station;
responding by said at least one neighboring base station by providing said serving base station with information related to reception of communications from said at least one MSS at said at least one neighboring base station;
selecting by said serving BS, which of the at least one neighboring base stations will be a target base station for future communications with said at least one MSS;
carrying out a handover procedure, following which said at least one MSS will receive and transmit communications via said target base station.

2. A method according to claim 1, wherein the step of transmitting information associated with said at least one MSS, is preceded by a step of determining that a handover procedure should be carried out for said at least one MSS.

3. A method according to claim 1, where said information transmitted comprises PHY and/or MAC information to allow identifying said at least one MSS by said at least one neighboring base station.

4. A method according to claim 1, wherein the step of responding by said at least one neighboring base station comprises providing said serving base station with values of pre-defined reception parameters associated with reception of communications exchanged between said at least one MSS and said serving base station, at the responding neighboring base station.

5. A method according to claim 1, wherein the step of transmitting information is carried out on a regular basis by said serving base station.

6. A method according to claim 5, wherein the information transmitted relates to at least one or more MSS which reception at said serving base station are the weakest from among MSS being in communication with said serving base station.
